(19) United States
(12) Patent Application Publication
(10) Pub. No.: US 2022/0387242 A1
(43) Pub. Date: Dec. 8, 2022

(54) Device Holder for Inversion Table

(71) Applicant: On Chong, Sunnyvale, CA (US)

(72) Inventor: On Chong, Sunnyvale, CA (US)

(73) Assignee: Innova Products, Inc., Sunnyvale, CA (US)

(21) Appl. No.: 17/340,274

(22) Filed: Jun. 7, 2021

(51) Int. Cl. A61H 1/02

(52) U.S. Cl. CPC A61H 1/0229; A61H 2201/0119; A61H 2201/1626; A61H 2203/0493; A61H 2201/1671

(57) ABSTRACT

A device holder for an inversion table. The device holder has a front portion, bottom portion, back portion, and lateral portions to retain a device placed into the device holder. The device holder may be attached to the fixed, non-rotating part of the inversion table or it may be attached to the rotating part of the inversion table.

### FIELD OF THE INVENTION

Generally, the present invention relates to a device holder for an inversion therapy table that allows a user to place a device, such as a phone or tablet.

### DESCRIPTION OF RELATED ART

Inversion tables are known for stretching the lower back and for providing temporary back pain relief. More generally, inversion therapy involves lying flat on your back at an angle or hanging upside down, in head-down position.

Current inversion tables do not provide a place for a user to place a device, such as a phone or tablet, into or onto the inversion table. A user may want to have a device in or on the table and within reach for numerous reasons. For example, a user may want to listen to music, make a phone call, answer a phone call, use a timer or alarm function (which may be suggested by a physician), or any of the other functions provided by the device. The user also might wish to connect with their physician via a call or video for guidance or instruction.

The present disclosures address at least some of the issues described above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The embodiments herein provide for a system and apparatus wherein an inversion table includes a device holder. The device holder should retain the device and not allow it to fall out, which potentially can lead to damage of the device. The device holder should retain the device even while the user is inverted.

The present invention provides a device holder with a bottom portion, front portion, back portion, and lateral portions to retain a device, such as a phone or tablet. In one embodiment, the device holder is attached to the fixed, non-rotating part of the inversion table. This will allow the device to be retained even while the user is inverted on the rotatable part of the inversion table.

In another embodiment, the device holder is attached to the rotatable part of the inversion table and further includes a top portion or a mechanism at the top to retain the device and prevent the device from falling out of the device holder. This top portion or top mechanism is particularly useful if the user is inverted, such that the device holder likewise would be inverted.

### BRIEF DESCRIPTION OF THE FIGURES

The disclosed subject matter will hereafter be described with reference to the accompanying drawings, wherein like reference numerals denote like elements, and:

FIG. 1 provides a perspective view of an inversion table with a device holder in accordance with some embodiments of the present invention.

FIG. 2 provides a closer perspective view of the inversion table with the device holder.

FIG. 3 provides another closer perspective view of the inversion table with the device holder.

FIG. 4 provides a front perspective view of the device holder.

FIG. 5 provides another front perspective view of the device holder.

FIG. 6 provides a rear perspective view of the device holder.

FIG. 7 provides another rear perspective view of the device holder.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

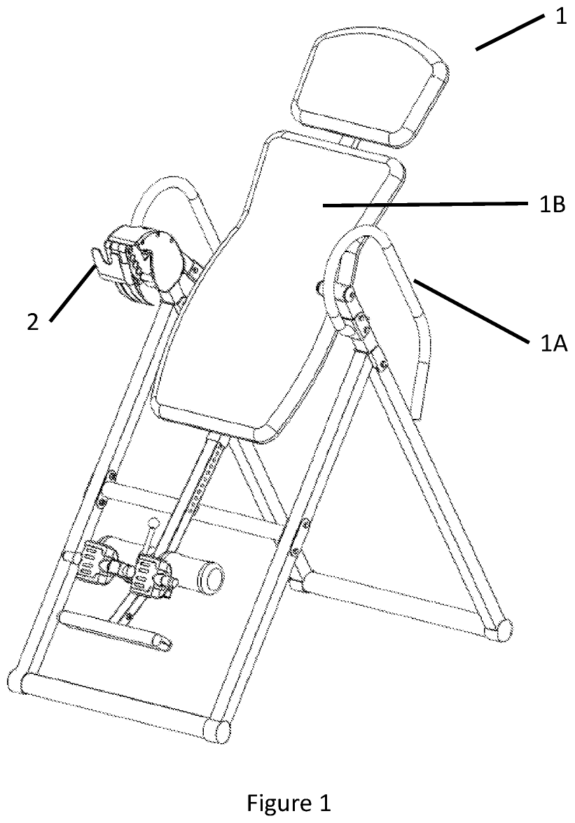

With reference to FIG. 1, an inversion table (1) is shown having a device holder (2). The inversion table (1) has a frame (1A) with a rotatable backrest (1B) attached rotatably thereto. The rotatable backrest (1B) can rotate with respect to the frame (1A), thereby providing inversion to a user.

The device holder (2) is attached to the frame (1A), thereby preventing rotation of the device holder if the backrest (1B) is rotated with respect to the frame (1A).

In a further embodiment, not shown here, the device holder may be attached to the rotatable backrest (1B) of the inversion table (1). The device holder (2) may further include a top portion or a strap, cap, or other similar structure or device to retain a device and prevent it from falling out of the device holder (2). This may be useful if the device holder (1) is inverted as the user is inverted.

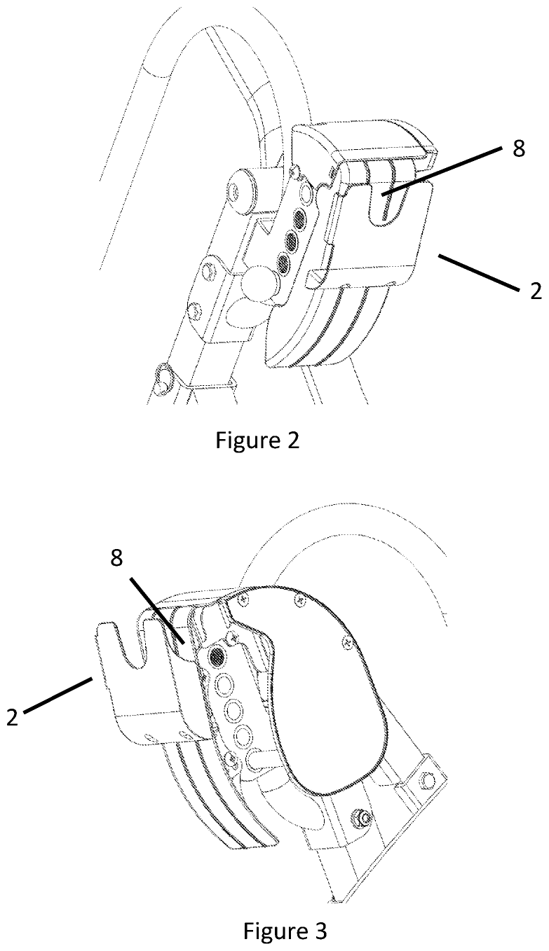

FIGS. 2 and 3 illustrate the device holder (2) attached to the frame (1A).

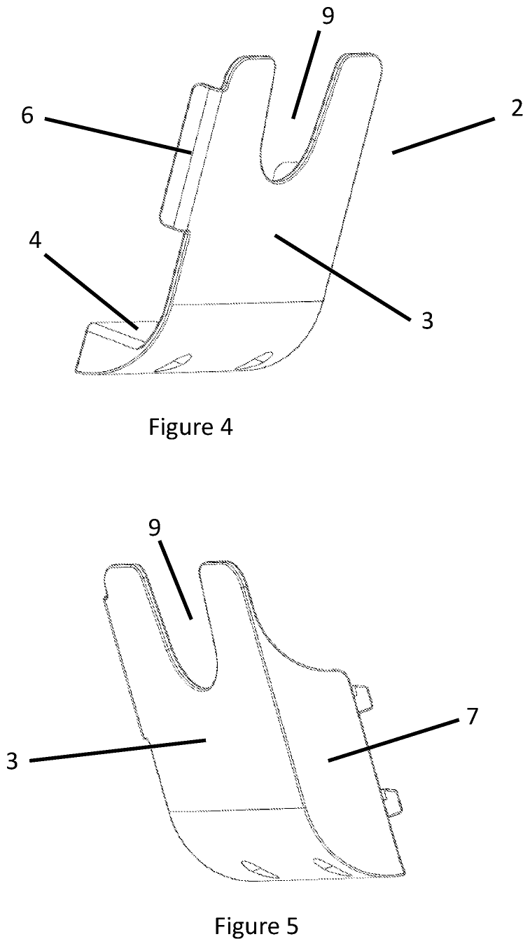

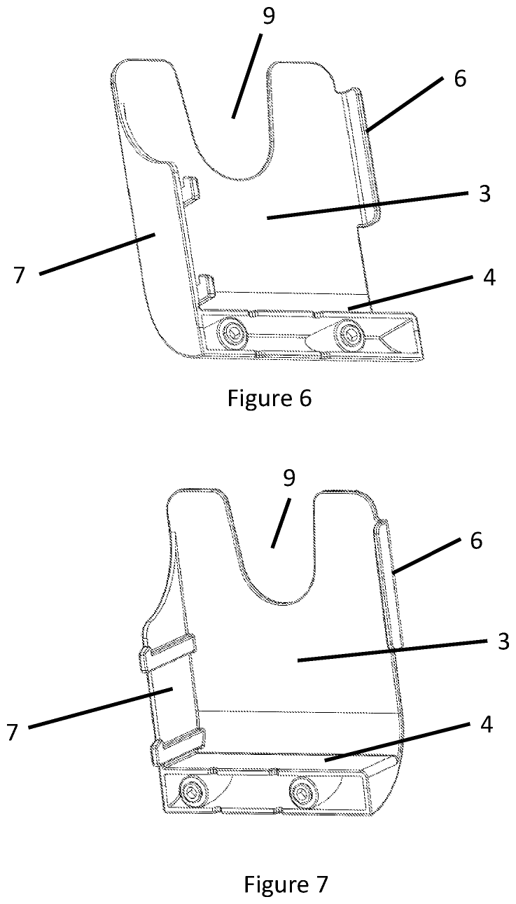

FIGS. 4-7 illustrate a front portion (3), bottom portion (4), and lateral portions (6 and 7) of the device holder (2). The front portion (3) is attached to the bottom portion (4). The lateral portions (6 and 7) are attached to the front portion (3). Although not illustrated here, the lateral portions (6 and 7) may be attached to the bottom portion (4).

FIGS. 2 and 3 also illustrate a back portion (8) of the device holder (2). The back portion (8) is attached to the bottom portion (4). Although not illustrated here, the back portion (8) may be attached to a lateral portion (7).

Together, the front portion (3), bottom portion (4), back portion (8), and lateral portions (6 and 7) serve to retain a device and prevent it from falling out, including if the user is inverting or inverted on the backrest (1B).

In another embodiment, the device holder (2) may include a slot (9) in the front portion (3). The slot (9) serves to aid in grabbing a device from the device holder, which may be particularly useful if the device is shorter than the height of the front portion (3). The slot (9) also makes a device in the device holder more visible. The slot (9) also provides room for devices that have attachments that otherwise would make the device too thick to fit in the device holder. Such an attachment may include a phone grip or similar device attached to a device.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

What is claimed is:

1. A device holder for an inversion table, the device holder comprising:
a front portion having a bottom end, a first side end, and a second side end,
a bottom portion connected to the bottom end of the front portion,
a back portion connected to the bottom portion,
a first lateral portion connected to at least one of the first side end of the front portion, the bottom portion, or the back portion,
a second lateral portion connected to at least one of the second side end of the front portion, the bottom portion, or the back portion.

2. The device holder of claim 1, wherein
the front portion has a top end with a slot in the top end.

3. The device holder of claim 1, further comprising:
a top portion located on the end opposite the bottom portion.

4. The device holder of claim 1, wherein
the front portion further comprises a top end,
a retention device located proximate the top end of the front portion.

5. An inversion table comprising:
a frame,
a backrest rotatably connected to the frame,
a device holder located on the frame,
the device holder comprising
a front portion having a bottom end, a first side end, and a second side end,
a bottom portion connected to the bottom end of the front portion,
a back portion connected to the bottom portion,
a first lateral portion connected to at least one of the first side end of the front portion, the bottom portion, or the back portion,
a second lateral portion connected to at least one of the second side end of the front portion, the bottom portion, or the back portion.

6. The inversion table of claim 5, wherein
the front portion of the device holder has a top end with a slot in the top end.

7. The inversion table of claim 5, further comprising:
a top portion located on the end opposite the bottom portion.

8. The inversion table of claim 5, wherein
the front portion further comprises a top end,
a retention device located proximate the top end of the front portion.

9. An inversion table comprising:
a frame,
a backrest rotatably connected to the frame,
a device holder located on the backrest,
the device holder comprising
a front portion having a bottom end, a first side end, and a second side end,
a bottom portion connected to the bottom end of the front portion,
a back portion connected to the bottom portion,
a first lateral portion connected to at least one of the first side end of the front portion, the bottom portion, or the back portion,
a second lateral portion connected to at least one of the second side end of the front portion, the bottom portion, or the back portion.

10. The inversion table of claim 9, wherein
the front portion of the device holder has a top end with a slot in the top end.

11. The inversion table of claim 9, further comprising:
a top portion located on the end opposite the bottom portion.

12. The inversion table of claim 9, wherein
the front portion further comprises a top end,
a retention device located proximate the top end of the front portion.
